(19) United States
(12) Patent Application Publication
(10) Pub. No.: US 2002/0002754 A1
(43) Pub. Date: Jan. 10, 2002

(54) Sandless drywall knife

(76) Inventor: Michael C. Wendel, Buffalo, NY (US)

Correspondence Address: Richard C. Litman, LITMAN LAW OFFICES, LTD., P.O. Box 15035, Arlington, VA, 22215, US

(21) Appl. No.: 09/850,903

(22) Filed: May 9, 2001

Related U.S. Application Data
(60) Provisional application No. 60/216,486, filed on Jul. 6, 2000.

(51) Int. Cl. B05C 17/10

(52) U.S. Cl. 15/245.1; 15/235.4; 15/236.01; 15/236.07

(57) ABSTRACT

A tool for spreading plaster comprises a knife blade with an edge configured as a concavity. In one embodiment, the concavity has a radius of curvature of approximately one-sixteenth of an inch and tapers to respective flat surfaces on each end of the blade. The blade is disposed on a handle for easy manipulation. The blade and handle may be fabricated from metal or plastic material and may be of one-piece design.

### CROSS-REFERENCE TO RELATED APPLICATION

This application claims the benefit of U.S. Provisional Patent Application Serial No. 60/216,486, filed Jul. 6, 2000.

### BACKGROUND OF THE INVENTION

1. Field of the Invention

The present invention generally relates to building construction tools. More specifically, the present invention is drawn to a hand tool utilized to apply plaster to drywall boards.

2. Description of Related Art

A sheet of standard four feet by eight feet drywall is usually tapered along the eight foot side (the four foot end is not tapered). Thus, when laid side to side a tapered joint is formed. However, when positioned end to end a butt joint is formed. It is common practice to tape the joints between the sheets of drywall and to cover the tape with an overlay of plaster. The plaster overlay must be sanded down so that the tape is not discernible and the entire surface appears to be smooth and even. While accomplishing this task (especially the butt seams) without an undue amount of sanding is mildly challenging to a professional, it is intimidating to the do-it-yourselfer. Surely an efficient, inexpensive tool that would enhance the application of plaster while reducing the need to sand would be a welcome addition in the art.

U.S. Pat. No. 2,934,936 (Vernon) shows a trowel used to apply plaster over a taped joint. The trowel is bowed along a relatively wide planar surface. Such trowels are effective in the hands of a seasoned professional but are frustratingly difficult for a novice to use.

U.S. Pat. No. 4,654,919 (Liberman) shows knife-like tool for spreading plaster on a drywall surface. The tool employs a surface which is half contoured and half planar. Use of the instant tool would require an amount of dexterity obtained only by repeated use.

U.S. Pat. No. 6,044,516 (Lev) and French Patent number 2,478,1689 (Venditti) disclose regular plastering trowels. These trowels are utilized to plaster extensive surface areas.

U.S. Pat. Nos. Des. 364,015 and 5,392,484 (Stoltzfus) are drawn to a tool for cleaning and finishing bullnose joints. U.S. Pat. No. Des. 416,453 (Eagan) discloses a tool for filling cracks. U.S. Pat. Nos. 2,944,275 (Markusen) and U.S. Pat. No. 4,207,674 (Heronema) show tools for scraping debris.

None of the above inventions and patents, taken either singly or in combination, is seen to disclose a sandless drywall knife as will subsequently be described and claimed in the instant invention.

### SUMMARY OF THE INVENTION

The present invention is drawn to a hand tool for plastering drywall. The tool allows a novice to cover drywall seams or repair walls and ceilings with little or no sanding while attaining professional results. The tool takes the form of a drywall knife. The knife has a blade which presents an edge of concave configuration having flat portions formed at each end of the concavity. The flat portions are designed to maintain constant contact with the drywall surface. This simplistic configuration allows a user to put an even amount of plaster over the seam tape or repair area therefore requiring less plaster. Thus, less sanding, cleanup and expense is required when the tool of the instant invention is employed.

Accordingly, it is a principal object of the invention to provide a tool for applying plaster to the surface of a drywall board.

It is another object of the invention to provide a tool for applying plaster to the surface of a drywall board, which tool applies the plaster in an even, efficient manner.

It is a further object of the invention to provide a tool for applying plaster to the surface of a drywall board, which tool applies plaster in a manner that requires little or no sanding.

Still another object of the invention is to provide a tool for applying plaster to the surface of a drywall board, which tool is easy to use.

It is an object of the invention to provide improved elements and arrangements thereof in a device for the purposes described which are inexpensive, dependable and fully effective in accomplishing their intended purposes.

These and other objects of the present invention will become readily apparent upon further review of the following specification and drawings.

### BRIEF DESCRIPTION OF THE DRAWINGS

FIG. 1 is an environmental, perspective view of a sandless drywall knife according to the present invention.

FIG. 2 is a perspective view of a first embodiment of a sandless drywall knife according to the present invention.

FIG. 3 is a perspective view of a second embodiment of a sandless drywall knife according to the present invention.

FIG. 4 is a perspective view of a third embodiment of a sandless drywall knife according to the present invention.

FIG. 5 is a plan view of a fourth embodiment of a sandless drywall knife according to the present invention.

Similar reference characters denote corresponding features consistently throughout the attached drawings.

### DETAILED DESCRIPTION OF THE PREFERRED EMBODIMENTS

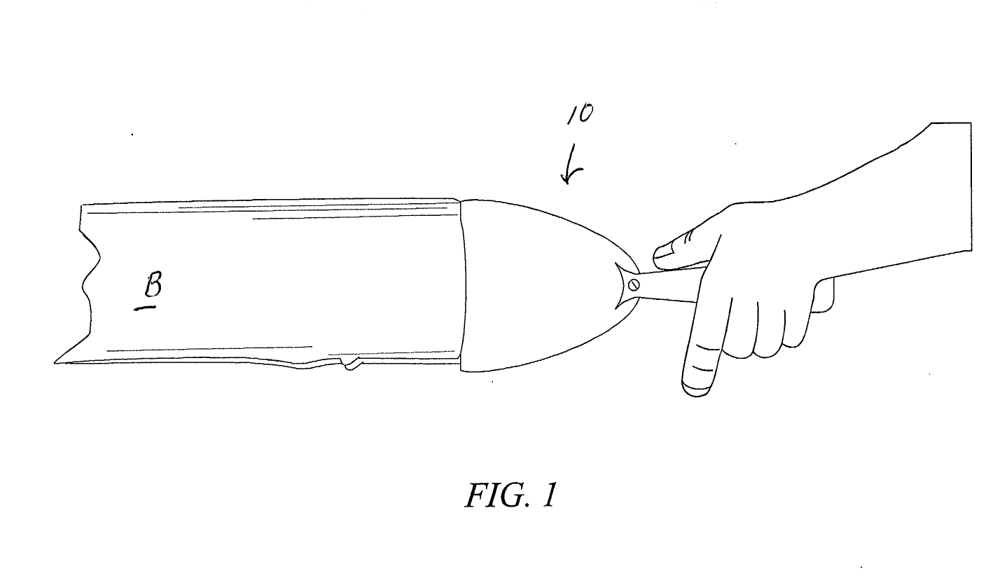

Attention is first directed to FIG. 1 wherein the sandless drywall knife of the present invention is generally indicated at 10. Knife 10, as illustrated, is used to apply a smooth layer of plaster to the surface of drywall B.

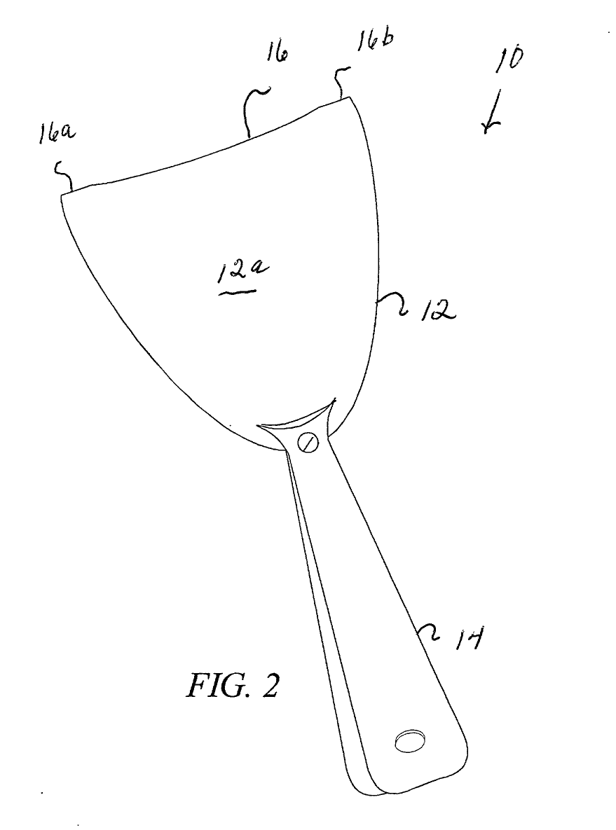

As best shown in FIG. 2, in a first embodiment, knife 10 comprises a blade 12 having respective planar front face 12a and an identical planar rear face (not shown) Blade 12 may be fabricated from metal or plastic material. Blade 12 may also be manufactured in the standard industry widths (6″, 8″, 10′, 12″). Blade 12 is disposed on a handle 14. Handle 14 is of a suitable length to be easily manipulated by a user. The handle may also be fabricated from metal or plastic material. It is contemplated that the blade and handle can take on a one-piece design (all metal or all plastic) if desired. When viewed from a planar front (or planar rear) face, blade 12 has an edge 16 of a slight concave configuration. For best results, it has been determined that the concavity should have a radius of curvature of about one-sixteenth of an inch and should extend approximately one inch from the center of the blade in either direction. The concavity tapers into flat surfaces 16a and 16b. Each flat surface 16a, 16b should extend approximately one-half of an inch from the end of the concavity to the extremity of edge 16.

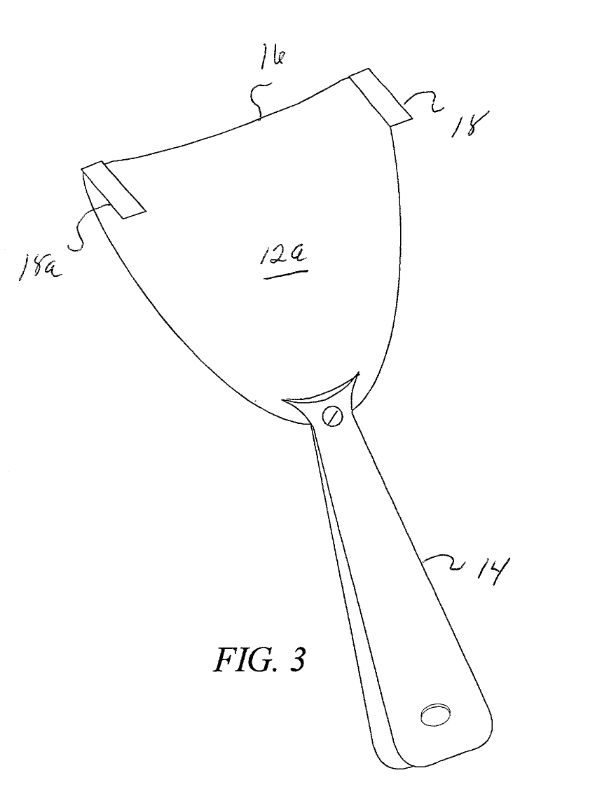

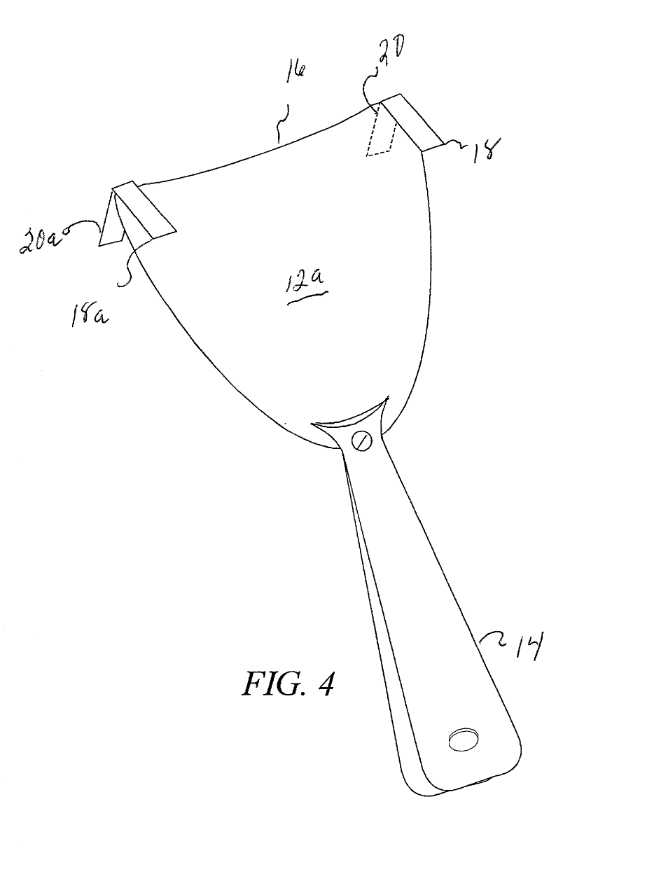

FIGS. 3 and 4 illustrate second and third embodiments of the invention described above. In FIG. 3 angle guides 18 and 18a are disposed on planar face 12a. Guides 18 and 18a function to position the blade at the proper angle to the drywall board making the spreading of the plaster easier and more efficient. FIG. 4 shows angle guides 20 and 20a (identical to 18, 18a) disposed on planar face 12b allowing a user to employ guides on both faces when applying plaster.

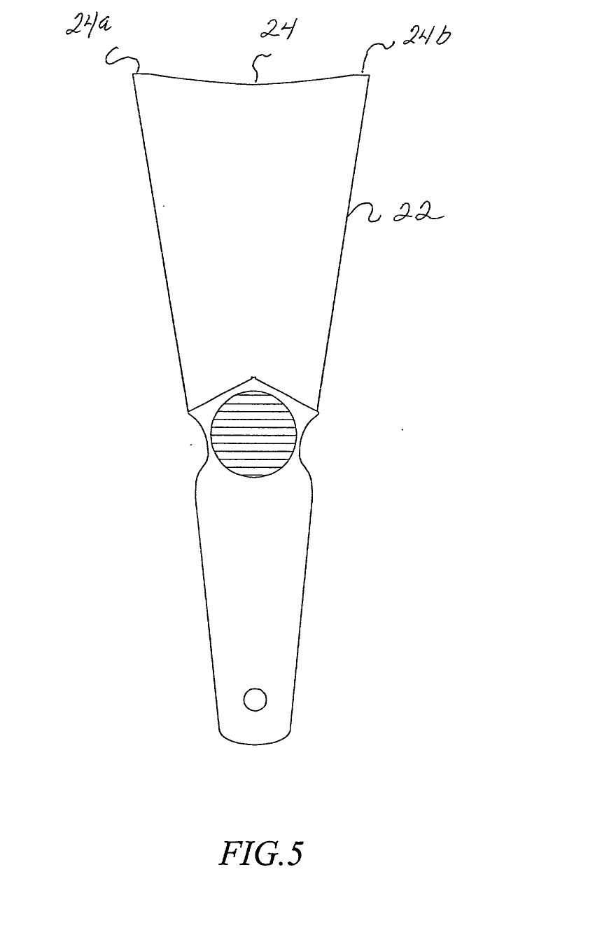

A popular tool used in the plastering art is the one and one-half inch knife (commonly called a putty knife) which is shown in FIG. 5 at 22. Because of the knife's size, it was determined that the radius of curvature of the concavity 24 should be approximately three-thirty seconds of an inch and that the flat surfaces 24a and 24b, at each end, should be about one-eighth of an inch. These dimensions have been found to give the best results.

It is to be understood that the present invention is not limited to the embodiments described above, but encompasses any and all embodiments within the scope of the following claims.

I claim:

1. A tool for spreading plaster on drywall boards, said tool comprising:
an elongate blade, said blade having a front planar surface, a rear planar surface, a first end and a second end;
a handle, said handle attached to said blade at said second end;
an edge defining said first end of said blade, said edge having a first and second extremities, each said first and second extremities having a width, said edge having a profile wherein said profile is configured as a concavity between said first and said second extremities and wherein said concavity has a radius of curvature of approximately one-sixteenth of an inch.

2. A tool for spreading plaster as recited in claim 1, wherein said first and said second extremities are flat.

3. A tool for spreading plaster as recited in claim 2, wherein the width of each said first and second extremities is approximately one-half of an inch.

4. A tool for spreading plaster as recited in claim 3, wherein said edge has a mid-point and said concavity extends approximately one inch from said mid-point in either direction.

5. A tool for spreading plaster as recited in claim 4, further comprising:
a first pair of small rectangular strip members, one of said pair of strip members disposed on said blade adjacent each said first and second extremities and extending angularly therefrom.

6. A tool for spreading plaster as recited in claim 5, wherein said first pair of strip members are disposed on said front planar surface of said blade.

7. A tool for spreading plaster as recited in claim 6, further comprising:
a second pair of small rectangular strip members, one of said second pair of strip members disposed on said blade adjacent each said first and second extremities and extending angularly therefrom, said second pair of strip members disposed on said rear planar surface of said blade.

8. A tool for spreading plaster as recited in claim 7, wherein said blade, said handle and said strip members are fabricated from a metallic material.

9. A tool for spreading plaster as recited in claim 7, wherein said blade, said handle and said strip members are fabricated from a plastic material.

10. A tool for spreading plaster on drywall boards, said tool comprising:
an elongate blade, said blade having a front planar surface, a rear planar surface, a first end and a second end;
a handle, said handle attached to said blade at said second end;
an edge defining said first end of said blade, said edge having a first and second extremities, each said first and second extremities having a width, said edge having a profile wherein said profile is configured as a concavity between said first and said second extremities and wherein said concavity has a radius of curvature of approximately three-thirty seconds of an inch.

11. A tool for spreading plaster as recited in claim 10, wherein said first and said second extremities are flat.

12. A tool for spreading plaster as recited in claim 11, wherein the width of each said first and second extremities is approximately one-eighth of an inch.

13. A tool for spreading plaster as recited in claim 12, wherein said blade and said handle are fabricated from a metallic material.

14. A tool for spreading plaster as recited in claim 12, wherein said blade and said handle are fabricated from a plastic material.
